(19) United States
(12) Patent Application Publication
(10) Pub. No.: US 2025/0126195 A1
(43) Pub. Date: Apr. 17, 2025

(54) EMERGENCY CALL RECORD AND ADDRESS VALIDATION

(71) Applicant: Level 3 Communications, LLC., Denver, CO (US)

(72) Inventors: Kimberly ADAMS, Westerville, OH (US); Anne KEMPEN, Denver, CO (US)

(73) Assignee: Level 3 Communications, LLC, Denver, CO (US)

(21) Appl. No.: 18/825,701

(22) Filed: Sep. 5, 2024

Related U.S. Application Data
(60) Provisional application No. 63/589,394, filed on Oct. 11, 2023.

(51) Int. Cl. H04M 3/32

(52) U.S. Cl. CPC H04M 3/323; H04M 2242/04

(57) ABSTRACT

Novel tools and techniques are provided for implementing emergency call record and address validation. In various embodiments, a computing system may simultaneously initiate two or more test calls among a plurality of test calls to an emergency service provider system. Each test call may simulate an emergency services validation call initiated from a telephone number among a plurality of telephone numbers associated with a corresponding plurality of users to request a determination as to whether a 911 or enhanced 911 (“E911”) address associated with the telephone number is an accurate 911 or E911 address. In response to receiving a corresponding plurality of call responses from the emergency service provider system, the computing system may analyze each call response to determine a result of each corresponding simulated emergency services validation call; and may send each determined result to a corresponding requesting party.

### CROSS-REFERENCE TO RELATED APPLICATIONS

This application claims the benefit of U.S. Provisional Application No. 63/589,394 filed Oct. 11, 2023, by Kimberly Adams et al., entitled “Emergency Call Record and Address Validation,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing public safety service point (“PSAP”) operations and functionalities, and, more particularly, to methods, systems, and apparatuses for implementing emergency call record and address validation.

### BACKGROUND

It is important for 911 or enhanced 911 (“E911”) addresses associated with corresponding telephone numbers that are associated with corresponding users to be accurate and correct for properly routing emergency calls from such telephone numbers so that emergency services can correctly assist such users. Traditionally, validation of 911 or E911 addresses requires manual validation by call center agents, which incurs costs in terms of time, money, and efficiency, especially when compounded by a large number of 911 or E911 addresses to be validated. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

FIG. 1 depicts a schematic diagram illustrating an example system for implementing emergency call record and address validation, in accordance with various embodiments.

FIG. 2 depicts an example sequence flow for implementing an example emergency call record and address validation process, in accordance with various embodiments.

FIGS. 3A and 3B depict various example sequence flows for implementing emergency call record and address validation functionalities, in accordance with various embodiments.

FIGS. 4A and 4B depict flow diagrams illustrating various example method for implementing emergency call record and address validation, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing public safety service point (“PSAP”) operations and functionalities, and, more particularly, to methods, systems, and apparatuses for implementing emergency call record and address validation.

In various embodiments, a computing system may receive, from at least one requesting application, two or more validation requests Each validation request is set or configured to request to validate a 911 or enhanced 911 (“E911”) address associated with a corresponding telephone number among a plurality of telephone numbers associated with a corresponding plurality of users. The computing system may route the two or more validation requests to a messaging bus that prioritizes a call queue for simultaneously initiating multiple test calls to an emergency service provider system. The computing system may simultaneously initiate two or more test calls among a plurality of test calls to the emergency service provider system, in some cases, based on the prioritized call queue. Each test call may simulate an emergency services validation call initiated from a telephone number among the corresponding plurality of telephone numbers associated with the corresponding plurality of users to request a determination as to whether a 911 or E911 address associated with the telephone number is an accurate 911 or E911 address and to request sending of a call response back to the computing system. In response to receiving a corresponding plurality of call responses from the emergency service provider system, the computing system may analyze each call response to determine a result of each corresponding simulated emergency services validation call; and may send each determined result to a corresponding requesting party.

In some embodiments, the computing system includes at least one of an emergency call record and address validation system, an emergency test call handler, a 911 or E911 address validation system, a 911 or E911 address change server, a network operations center (“NOC”), a cloud computing system, or a distributed computing system, and/or the like. According to some embodiments, for determined results associated with first test calls among the two or more test calls that are positive, each determined positive result includes a telephone number corresponding to one of the two or more test calls, the corresponding 911 or E911 address, and information regarding a corresponding PSAP among a plurality of PSAPs to which emergency calls from said telephone number are directed. On the other hand, for determined results associated with second test calls among the two or more test calls are negative, each determined negative result includes the corresponding telephone number and a message indicating that the corresponding 911 or E911 address is unknown and indicating that the corresponding test call will be routed to a call center for updating the corresponding 911 or E911 address.

The various embodiments provide for an automated process to ensure that a 911 or E911 address listed for an emergency call record is accurate as detected when a test call is made. In some examples, repeated attempts can be made if validation is unsuccessful to continually notify the end user, entity, or requesting party to fix the call record until the validation succeeds. In this manner, the validation process is streamlined and efficiencies may be achieved in terms of costs and time, while reducing the amount of manual interaction as with traditional approaches. These and other aspects of the emergency call record and address validation are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In an aspect, the technology relates to a method including simultaneously initiating, by a computing system, two or more test calls among a plurality of test calls to an emergency service provider system. Each test call may simulate an emergency services validation call initiated from a telephone number among a plurality of telephone numbers associated with a corresponding plurality of users to request a determination as to whether a 911 or E911 address associated with the telephone number is an accurate 911 or E911 address and to request sending of a call response back to the computing system. The method further includes, in response to receiving a corresponding plurality of call responses from the emergency service provider system, analyzing, by the computing system, each call response to determine a result of each corresponding simulated emergency services validation call; and sending, by the computing system, each determined result to a corresponding requesting party.

In some embodiments, the computing system includes at least one of an emergency call record and address validation system, an emergency test call handler, a 911 or E911 address validation system, a 911 or E911 address change server, a NOC, a cloud computing system, or a distributed computing system, and/or the like.

According to some embodiments, the method further includes receiving, by the computing system and from at least one requesting application, two or more validation requests corresponding to the two or more test calls. Each validation request is set to request to validate a 911 or E911 address associated with a corresponding telephone number among the plurality of telephone numbers associated with the corresponding plurality of users. The method further includes routing, by the computing system, the two or more validation requests to a messaging bus that prioritizes a call queue for simultaneously initiating the two or more test calls to the emergency service provider system. In some instances, each of the two or more validation requests is sent from the at least one requesting application in response to one of: a manual request from a requesting party, wherein the requesting party is one of a user associated with a telephone number corresponding to one of the two or more validation requests or a service representative of a service provider providing a voice service associated with the telephone number; or an automated request by the at least one requesting application on behalf of the user associated with the telephone number corresponding to one of the two or more validation requests, wherein the automated request is initiated as one of a periodic automated request, a scheduled automated request, or a triggered automated request.

In some examples, the triggered automated request is initiated in response to a trigger including one of a request for a new voice service subscription, a request for a change in voice service subscription, a request for a new telephone number, a request for a change of users to whom the voice service is assigned, a request for a change of users to whom a telephone number is assigned, a request for updating a user's address, or an on-demand request to validate a 911 or E911 address by a user, and/or the like. In some cases, at least one of the two or more validation requests and at least one of the two or more test calls among the plurality of test calls each includes the corresponding telephone number and the corresponding 911 or E911 address associated with said telephone number. In some instances, determining whether the corresponding 911 or E911 address associated with said telephone number is an accurate 911 or E911 address includes determining whether the corresponding 911 or E911 address associated with said telephone number matches a corresponding 911 or E911 address that is stored in a database containing 911 or E911 addresses that have previously been validated.

In examples, each 911 or E911 address for the corresponding telephone number associated with a corresponding one of the two or more test calls is stored in 911 or E911 address data. For each of the two or more test calls, determining whether a 911 or E911 address associated with a corresponding telephone number is an accurate 911 or E911 address includes comparing each 911 or E911 address for the corresponding telephone number associated with a corresponding one of the two or more test calls with a corresponding address contained in a government postal address database.

In some cases, analyzing each call response includes analyzing, by the computing system, each call response using at least one of voice recognition technology, call detail record analysis, log data analysis, or analysis of unique tones generated by the emergency service provider system, and/or the like, to determine the result of each corresponding simulated emergency services validation call.

In some instances, sending each determined result to a corresponding requesting party includes sending each determined result to a corresponding requesting party via at least one of a service order user interface (“UI”), an email message, a test message, a telephone or voice call to a corresponding telephone number associated with a corresponding user among the plurality of users, or a telephone or voice call to an administrator telephone number associated with one or more of the corresponding telephone number or the corresponding user, and/or the like.

In some embodiments, sending each determined result includes, based on a determination that a determined result among the determined results associated with two or more test calls is positive, sending the determined result to the corresponding requesting party, the determined result including the corresponding telephone number, the corresponding 911 or E911 address, and information regarding a corresponding PSAP among a plurality of PSAPs to which emergency calls from the corresponding telephone number are directed. Alternatively or additionally, sending each determined result includes, based on a determination that a determined result among the determined results associated with two or more test calls is negative, sending the determined result to the corresponding requesting party, the determined result including the corresponding telephone number and a message indicating that the corresponding 911 or E911 address is unknown and indicating that the corresponding test call will be routed to a call center for updating the corresponding 911 or E911 address.

In another aspect, the technology relates to a system including a 911 validation endpoint system configured to receive validation requests from at least one requesting application to validate a first plurality of 911 or E911 addresses associated with a first plurality of telephone numbers that is associated with a corresponding first plurality of users; and a messaging bus configured to control and prioritize a call queue based on the requests received from the 911 validation endpoint system. The system further includes an emergency test call handler configured to simultaneously initiate two or more test calls among a plurality of test calls to an emergency service provider system and to receive a corresponding plurality of call responses from the emergency service provider system, each test call simulating an emergency services validation call initiated from a telephone number among the first plurality of telephone numbers. The system further includes a response analysis system configured to, in response to receiving the corresponding plurality of call responses, analyze the plurality of call responses to determine results of each emergency services validation call simulated by the plurality of test calls and to send the determined results to each corresponding requesting party.

According to some embodiments, the response analysis system is configured to analyze the plurality of call responses to determine results of each emergency services validation call by performing at least one of: analyzing each call response using at least one of voice recognition technology, call detail record analysis, log data analysis, or analysis of unique tones generated by the emergency service provider system to determine the results of each corresponding simulated emergency services validation call; determining whether the corresponding 911 or E911 address associated with the corresponding telephone number matches a 911 or E911 address that is stored in a database containing 911 or E911 addresses that have previously been validated; or comparing each 911 or E911 address for the corresponding telephone number associated with a corresponding one of the two or more test calls with a corresponding address contained in a government postal address database; and/or the like.

In yet another aspect, the technology relates to a method including initiating, by a computing system, a first test call to an emergency service provider system. The first test call may simulate an emergency services validation call initiated from a first telephone number associated with a first user to request a determination as to whether a 911 or E911 address associated with the first telephone number is an accurate 911 or E911 address and to request sending of a call response back to the computing system. The method further includes, in response to receiving the call response from the emergency service provider system, analyzing, by the computing system, the call response to determine a result of the simulated emergency services validation call; and sending, by the computing system, the determined result to a requesting party. In some cases, the requesting party includes the first user, an agent of the first user, or a service representative of a service provider providing a voice service associated with the first telephone number, and/or the like.

In some embodiments, the computing system includes at least one of an emergency call record and address validation system, an emergency test call handler, a 911 or E911 address validation system, a 911 or E911 address change server, a NOC, a cloud computing system, or a distributed computing system, and/or the like.

In examples, the method further includes receiving, by the computing system and from a requesting application, a first validation request to validate a first 911 or E911 address associated with the first telephone number among a plurality of telephone numbers associated with a corresponding plurality of users. The method further includes routing, by the computing system, the first validation request to a messaging bus that prioritizes a call queue for simultaneously initiating a plurality of test calls to the emergency service provider system, the plurality of test calls simulating emergency services validation call initiated from a corresponding plurality of telephone numbers associated with a corresponding plurality of users.

In some instances, the first validation request is sent from the requesting application in response to one of: a manual request from the requesting party; or an automated request by the requesting application on behalf of the requesting party, and/or the like. In some cases, the automated request is initiated as one of a periodic automated request, a scheduled automated request, or a triggered automated request, and/or the like. In some examples, the triggered automated request is initiated in response to a trigger including one of a request for a new voice service subscription, a request for a change in voice service subscription, a request for a new telephone number, a request for a change of users to whom the voice service is assigned, a request for a change of users to whom a telephone number is assigned, a request for updating a user's address, or an on-demand request to validate a 911 or E911 address by a user, and/or the like.

According to some embodiments, the first validation request and a first test call among the plurality of test calls each includes the first telephone number and the first 911 or E911 address associated with the telephone number. In some instances, determining whether the 911 or E911 address associated with the telephone number is an accurate 911 or E911 address includes determining whether the first 911 or E911 address associated with the first telephone number matches a 911 or E911 address that is stored in a database containing 911 or E911 addresses that have previously been validated. In some cases, sending the determined result to the requesting party includes sending the determined result to the requesting party via at least one of a service order UI, an email message, a test message, a telephone or voice call to a corresponding telephone number associated with the first user, or a telephone or voice call to an administrator telephone number associated with one or more of the first telephone number or the first user, and/or the like.

In some embodiments, sending the determined result to the requesting party includes, based on a determination that the determined result associated with the first test call is positive, sending the determined result to the requesting party. The determined result includes the first telephone number, the 911 or E911 address associated with the first telephone number, and information regarding a corresponding PSAP among a plurality of PSAPs to which emergency calls from the first telephone number are directed. Alternatively or additionally, sending the determined result to the requesting party includes, based on a determination that the determined result associated with the first test call is negative, sending the determined result to the requesting party, the determined result including the first telephone number and a message indicating that the 911 or E911 address associated with the first telephone number is unknown and indicating that the first test call will be routed to a call center for updating said 911 or E911 address.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### SPECIFIC EXEMPLARY EMBODIMENTS

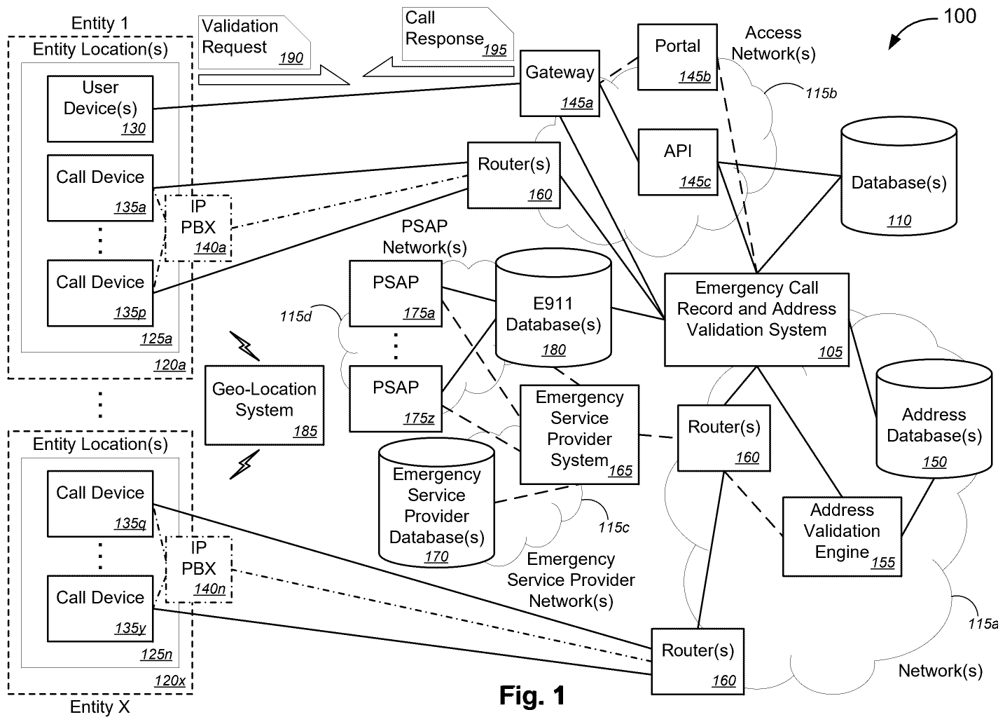

We now turn to the embodiments as illustrated by the drawings. FIGS. 1-5 illustrate some of the features of the method, system, and apparatus for implementing PSAP operations and functionalities, and, more particularly, to methods, systems, and apparatuses for implementing emergency call record and address validation, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts a schematic diagram illustrating an example system 100 for implementing emergency call record and address validation, in accordance with various embodiments.

In the non-limiting embodiment of FIG. 1, system 100 may include an emergency call record and address validation system 105 and corresponding database(s) 110 that may be disposed or located within network(s) 115a and/or access network(s) 115b (which may be part of network(s) 115a associated with a first service provider, an extension of network(s) 115a, or a different but communicatively coupled network(s) with respect to network(s) 115a (in some cases, associated with a second service provider different from the first service provider), or the like). One or more entities 1 through X 120a-120x, who may be associated with, or may have service arrangements with the first service provider for, corresponding one or more entity locations 125a-125n (collectively, “entity locations 125” or the like), each of which may include, without limitation, at least one of a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, a hospital or other medical facility, a research facility, a university (or other post-secondary) building or buildings within a campus, and/or the like. In cases where users in an MDU are moved around, such as in universities, office buildings, etc., or in remote work situations, having updated and accurate 911 or E911 is important to correctly route emergency calls to appropriate PSAPs. At the entity location(s) 125, the entity may have, or may be associated with, one or more user devices 130, one or more call devices 135a-135y (collectively, “call devices 135” or the like), and, in some cases, an Internet Protocol private branch exchange(s) (“IP PBX(s)”) 140a-140n (collectively, “IP PBX 140” or the like). In some cases, call devices 135a-135p and corresponding IP PBX 140a may be disposed or located at, or assigned to, entity location(s) 125a, while call devices 135q-135y and corresponding IP PBX 140n may be disposed or located at, or assigned to, entity location(s) 125n, and call devices 135p-135q and corresponding IP PBX 140b-140 [n−1] may be disposed or located at, or assigned to, entity locations 125b-125 [n−1] (not shown).

In some embodiments, the emergency call record and address validation system 105 may include, without limitation, at least one of an emergency test call handler, a 911 or E911 address validation system, a 911 or E911 address change server, a NOC, a cloud computing system, or a distributed computing system, and/or the like. In some cases, the one or more user devices 130 may each include, but is limited to, one of a desktop computer, a laptop computer, a tablet computer, a smart phone, a mobile phone, or any suitable device capable of communicating with emergency call record and address validation system 105 via a web-based portal, an application programming interface (“API”), a server, a software application (“app”), or any other suitable communications interface, or the like. In some instances, the one or more call devices 135 may each include, without limitation, one of a voice over Internet Protocol (“VoIP”)-capable wired telephone, a desktop computer with VoIP communications software or app, a laptop computer with VOIP communications software or app, a tablet computer with VOIP communications software or app, a smart phone with VoIP communications software or app, a mobile phone with VOIP communications software or app, or any other suitable call device with VoIP communications software or app, or the like. In some cases, at least one user device 130 may overlap with, or may be the same as, at least one call device 135. Alternatively, or additionally, at least one other user device 130 may be different from at least one other call device 135 (which, in such cases, may be a dedicated call device, or the like). In some instances, the IP PBX 140 may include a VoIP gateway, and in some cases may connect telephone extensions to a public switched telephone network (“PSTN”) while providing internal communication among the call devices 135. The call devices 135 may communicatively couple with the corresponding IP PBX 140 over wired or wireless connections within entity location(s) 125 (as depicted in FIG. 1 by solid lines connecting call devices 135 with corresponding routers 160). Alternatively, the at least one call device 135 may communicatively couple with network(s) 115a and/or 115b without routing through the corresponding IP PBX 140 (i.e., by communicatively coupling directly with router(s) 160, or the like; as depicted in FIG. 1 by dot-dashed lines connecting call devices 135 with corresponding routers 160 via corresponding IP PBXs 140).

According to some embodiments, system 100 may further include at least one of gateway 145a, portal 145b, and/or API 145c, in some cases, disposed or located within access network(s) 115b or the like. In some instances, emergency call record and address validation system 105 may communicatively couple with each of the at least one of gateway 145a, portal 145b, and/or API 145c, either directly or indirectly. System 100 may further include a service provider address database(s) 150, an address validation engine 155, and a plurality of nodes or routers 160, each of which may be disposed in network(s) 115a and/or 115b. The service provider address database(s) 150 may be configured to store entity information, including, but not limited to, its copy of each entity's 911 or E911 address, or the like. The address validation engine 155 may be configured to validate an entity's 911 or E911 address that is being queried, added, updated, or changed, in some cases, against a standard address format, including, but not limited to, one of an automatic location identification (“ALI”) database address format, a master street address guide (“MSAG”) address format, a United States Postal Service (“USPS”) database address format, or North American 9-1-1 Resource Database address format, and/or the like. In some examples, the plurality of routers 160 is configured to route and/or establish session initiation protocol (“SIP”)-based communication sessions throughout the network(s) 115a and/or 115b. In some cases, each SIP-based communication may include, without limitation, at least one of a VoIP call, an IP-based video call, or an instant message over IP, and/or the like.

In some embodiments, system 100 may further include an emergency service provider system or server 165 and corresponding emergency service provider database(s) 170, which may both be disposed within an emergency service provider network(s) 115c (which, like network(s) 115b, may be part of network(s) 115a associated with a first service provider, an extension of network(s) 115a, or a different but communicatively coupled network(s) with respect to network(s) 115a (in some cases, associated with a third service provider different from one or both of the first service provider or the second service provider), or the like). In some cases, the emergency service provider system or server 165 may include a third-party vendor system or server. According to some embodiments, system 100 may further include one or more public safety access points (“PSAPs”) 175a-175z (collectively, “PSAPs 175” or the like) and corresponding E911 database(s) 180, which may both be disposed within a PSAP network(s) 115d (which, like network(s) 115b or 115c, may be part of network(s) 115a associated with a first service provider, an extension of network(s) 115a, or a different but communicatively coupled network(s) with respect to network(s) 115a (in some cases, associated with a fourth service provider different from one or more of the first service provider, the second service provider, and/or the third service provider), or the like). In some embodiments, one or more of the address database(s) 150, the emergency service provider database(s) 170, and/or the E911 database(s) 180 may each include, without limitation, at least one of an ALI database, a MSAG, a USPS database, or North American 9-1-1 Resource Database, and/or the like. Herein, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.), while p and q are non-negative integer numbers that are smaller in value than the value of y, where p is a number smaller than q.

The emergency service provider, using the emergency service provider server or system 165, may be configured to, in response to the entity 120 initiating a 911 emergency call, route the 911 emergency call to a local PSAP 175 among the one or more PSAPs 175 on behalf of the entity 120 or the service provider. The emergency service provider, using the emergency service provider server or system 165, may also be configured to validate or verify 911 or E911 addresses of the entity 120, in some cases, against a standard address format, including, but not limited to, one of an ALI database address format, a MSAG address format, a USPS database address format, or North American 9-1-1 Resource Database address format, and/or the like. The emergency service provider, using the emergency service provider server or system 165, may be further configured to update one or more PSAPs 175 and/or the E911 database(s) 180. The emergency service provider database(s) 170 may be configured to store entity information, including, but not limited to, its copy of each entity's 911 or E911 address, or the like. The E911 database(s) 180 may be configured to store entity addresses that would be relied upon and used by local PSAPs 175 when dispatching first responders (e.g., law enforcement units, firefighting units, and/or paramedic units, or the like) to the entity location(s) 125a-125n.

According to some embodiments, network(s) 115a, access network(s) 115b, emergency service provider network(s) 115c, and/or PSAP network(s) 115d may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 115a, 115b, 115c, and/or 115d may each include an access network of the service provider (e.g., an Internet service provider (“ISP”)). In another embodiment, the network(s) 115a, 115b, 115c, and/or 115d may each include a core network of the service provider and/or the Internet.

In examples, geo-location data-which may be provided to user device(s) 130 and/or call device(s) 135a-135y from a geo-location source such as geo-location system 185, or the like—may be used to provide location data that may be used to provide or generate a 911 or E911 address. In some cases, the geo-location data may include, without limitation, one of global positioning system (“GPS”) data, assisted GPS (“A-GPS”) data, global navigation satellite system (“GLONASS”) data, assisted GLONASS (“A-GLONASS”) data, Galileo global navigation satellite system (“GNSS”) data, BeiDou navigation satellite system (“BDS”) data, geographic information system (“GIS”) data, geocoded address data, cellular network radiolocation-based data, wireless phase one (“WPH1”) location data, or wireless phase two (“WPH2”) location data, and/or the like.

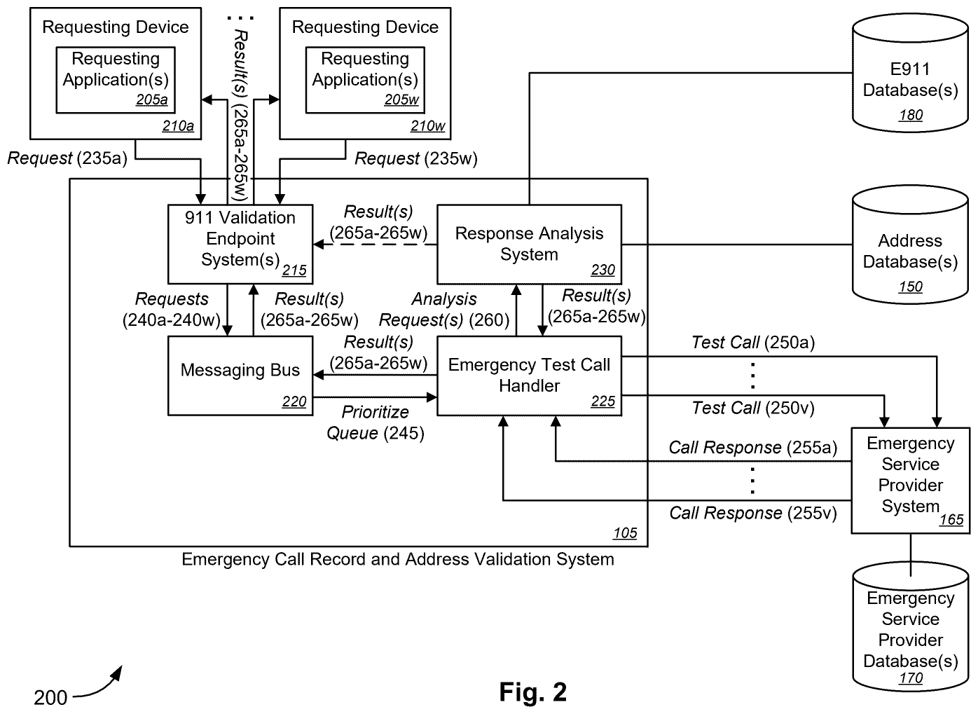

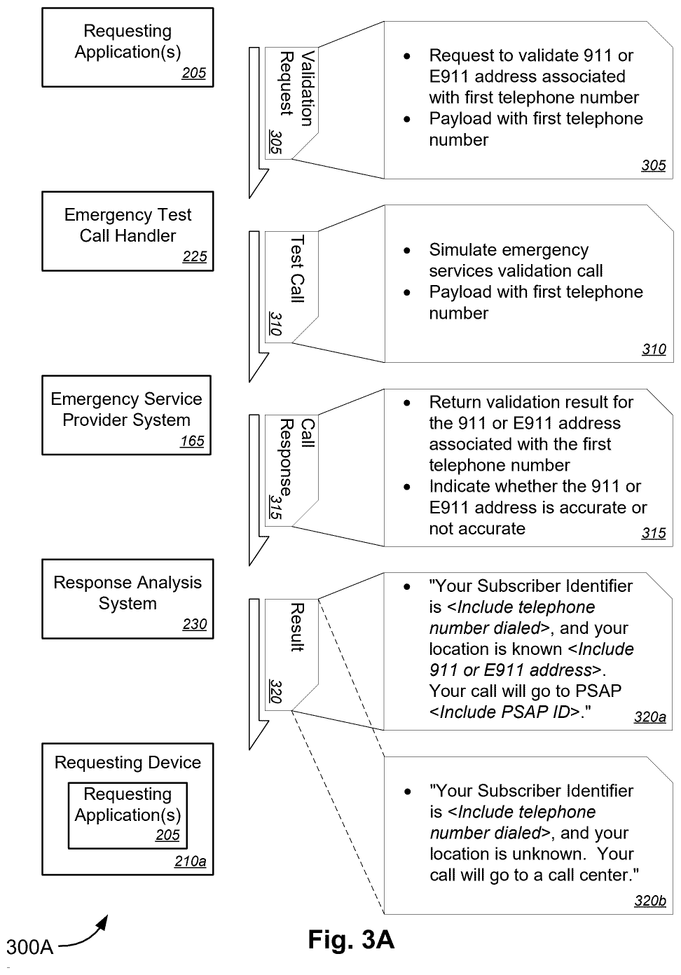

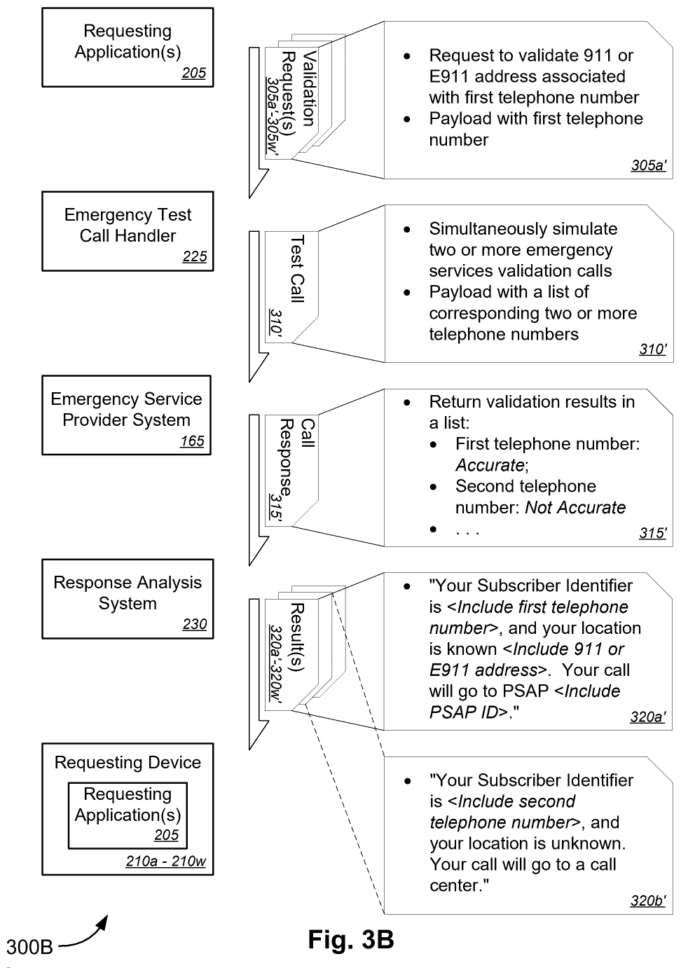

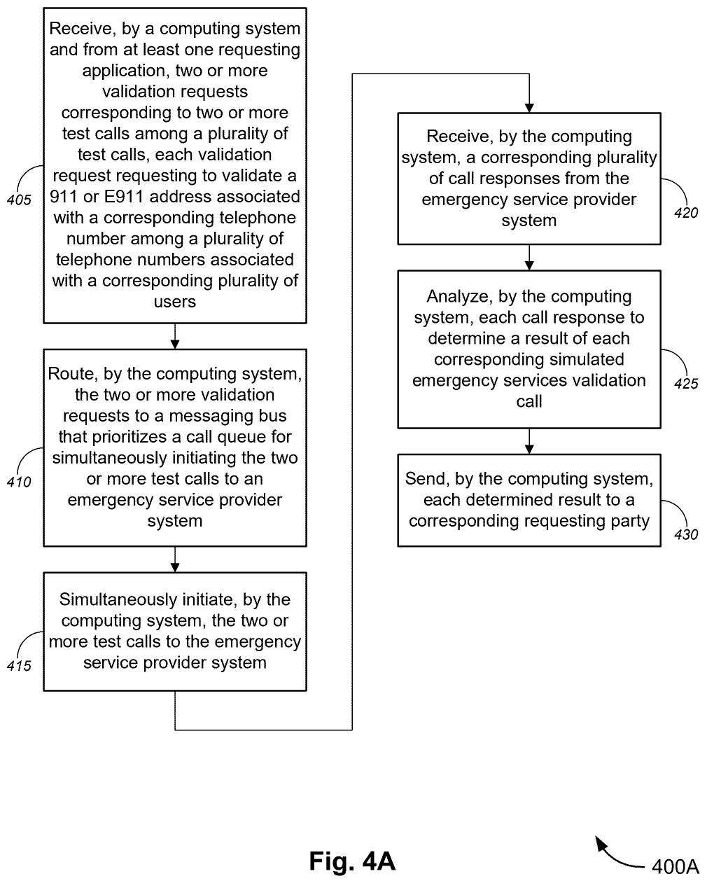

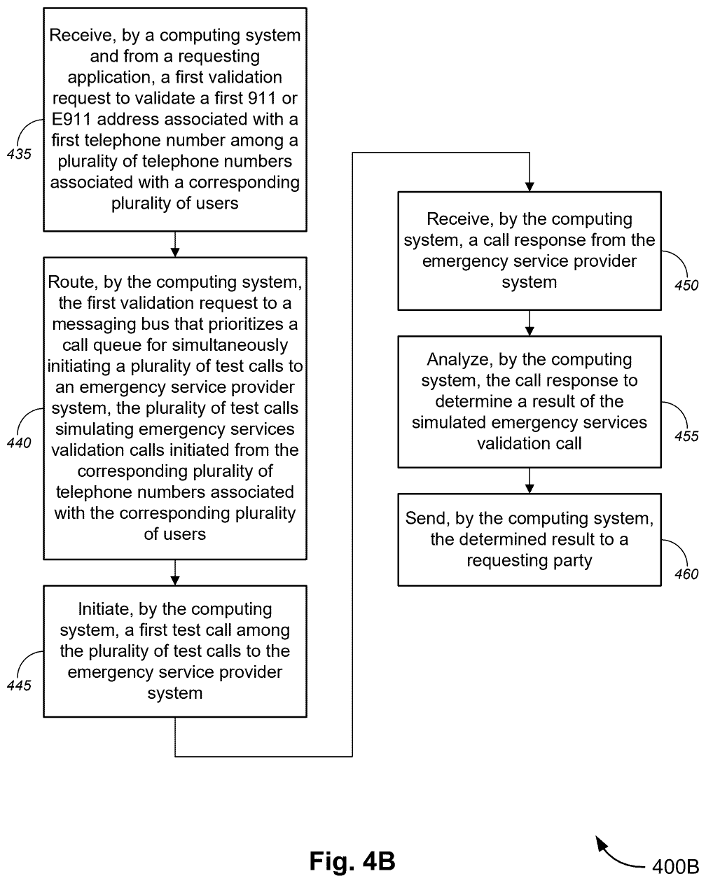

In operation, emergency call record and address validation system 105 (as referred to herein as “computing system”) may perform methods for implementing emergency call record and address validation, as described in detail with respect to FIGS. 2-4. For example, each of at least one entity 120, at least one user device 130, and/or at least one call device 135 may send a validation request 190 to emergency call record and address validation system 105, e.g., via gateway 145a and/or via portal 145b or API 145c. Emergency call record and address validation system 105 may query emergency service provider system 165 (or relay validation request 190 to emergency service provider system 165) via router(s) 160. In examples, FIG. 2 is directed to an example sequence flow 200 for implementing an example emergency call record and address validation process, in some cases, using emergency call record and address validation system 105 or the like, while FIGS. 3A and 3B are directed to various example sequence flows 300A and 300B for implementing emergency call record and address validation functionalities. FIGS. 4A and 4B are directed to an example method 400 for implementing emergency call record and address validation.

FIG. 2 depicts an example sequence flow 200 for implementing an example emergency call record and address validation process, in accordance with various embodiments. In some embodiments, emergency call record and address validation system 105, address database(s) 150, emergency service provider system 165, emergency service provider database(s) 170, E911 database(s) 180, and requesting devices 210a-210w of FIG. 2 may be similar, if not identical, to the emergency call record and address validation system 105, the address database(s) 150, the emergency service provider system or server 165, the emergency service provider database(s) 170, the E911 database(s) 180, and the user device(s) 130 and/or the call devices 135a-135y, respectively, of system 100 of FIG. 1, and the description of these components of system 100 of FIG. 1 are similarly applicable to the corresponding components of FIG. 2.

With reference to the non-limiting example 200 of FIG. 2, emergency call record and address validation system 105 may include 911 validation endpoint system(s) 215, messaging bus 220, emergency test call handler 225, and response analysis system 230. In examples, 911 validation endpoint system(s) 215 is configured to receive validation requests (e.g., one or more requests 235a-235w (collectively, “requests 235”)) from at least one requesting application (e.g., one or more requesting applications 205a-205w (collectively, “requesting applications 205”), in some cases, from or via corresponding one or more requesting devices 210a-210w (collectively, “requesting devices 210”)) to validate a first plurality of 911 or E911 addresses associated with a first plurality of telephone numbers that is associated with a corresponding first plurality of users (e.g., entities 120a-120x of FIG. 1, or the like). In some instances, messaging bus 220 is configured to control and prioritize a call queue 245 based on the requests 240a-240w (collectively, “requests 240”) received from the 911 validation endpoint system 215, the requests 240a-240w corresponding to requests 235a-235w, respectively.

In some examples, emergency test call handler 225 is configured to simultaneously initiate two or more test calls 250a-250v (collectively, “test calls 250”) among a plurality of test calls to emergency service provider system 165 based on the prioritized queue 245, and to receive a corresponding plurality of call responses 255a-255v (collectively “call responses 255”) from the emergency service provider system 165. In examples, a maximum number of simultaneous test calls to the emergency service provider system 165 (e.g., 10 simultaneous test calls, or the like) may be determined and/or set by the emergency service provider system 165 or by the service provider associated with emergency service provider system 165. Each test call 250 may simulate an emergency services validation call initiated from a telephone number among the first plurality of telephone numbers. In some cases, emergency service provider system 165 may utilize emergency service provider database(s) 170, which may contain 911 or E911 addresses that have been previously validated or not (e.g., labelled as accurate or not accurate, and/or known or not known), in providing validation results for generating and sending call responses 255a-255v in response to receiving corresponding test calls 250a-250v.

In some cases, response analysis system 230 is configured to, receiving analysis request(s) 260 including validation results contained in the call responses 255a-255v and/or including the call responses 255a-255v themselves. In response to receiving the corresponding analysis request(s) 260, response analysis system 230 is further configured to analyze at least one of the analysis request(s) 260, the plurality of call responses 255a-255v, and/or validation results contained in the call responses 255a-255v, and/or the like, to determine results of each emergency services validation call simulated by the plurality of test calls 250a-250v. In some cases, response analysis system 230 may utilize address database(s) and/or E911 database(s) 180, which may contain government postal addresses in particular standard address formats (e.g., ALI, MSAG, USPS, and/or North American 9-1-1 resource database formats, or the like) and/or 911 or E911 addresses that have been previously validated or not (e.g., labelled as accurate or not accurate, and/or known or not known), in providing analysis results for generating and sending results 265a-265w in response to receiving the analysis request(s) 260. The response analysis system 230 is further configured to send the determined results 265a-265w, respectively, to at least one of each corresponding requesting party, each corresponding requesting application 205, or each corresponding requesting device 210, and/or the like. Herein, n, v, w, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

In some cases, the results 265a-265w may be sent directly to 911 validation endpoint system(s) 215, as depicted in FIG. 2 by long-dashed lined arrow between response analysis system 230 and 911 validation endpoint system(s) 215. In other cases, the results 265a-265w may be sent indirectly to 911 validation endpoint system(s) 215 via emergency test call handler 225, messaging bus 220, and 911 validation endpoint system(s) 215, as depicted in FIG. 2 by solid lined arrows from response analysis system 230, to emergency test call handler 225, to messaging bus 220, and to 911 validation endpoint system(s) 215. 911 validations endpoint system(s) 215 is further configured to send results 265a-265w to the at least one of each corresponding requesting party, each corresponding requesting application 205, or each corresponding requesting device 210, and/or the like.

In some aspects, once validation is complete, for 911 or E911 addresses that are known and valid, the system (e.g., the emergency call record and address validation system 105) may, in some cases, initiate processes to verify or confirm whether or not the 911 or E911 addresses are up-to-date and accurate. In examples, verification may be made by response analysis system 230, in some cases, using address data contained in address database(s) 150 and/or E911 database(s) 180, or the like. In other examples, verification may be made by a system that communicates with the requesting party (e.g., an end user associated with the telephone number being verified, an agent of the end user, or a service representative of a service provider providing a voice service associated with the telephone number being verified, and/or the like). Verified 911 or E911 addresses either may be left changed in one or more appropriate databases (e.g., address database(s) 150, emergency service provider database(s) 170, and/or E911 database(s) 180, or the like) or may be labelled, by the system, as valid, verified, accurate, and/or up-to-date in the one or more appropriate databases. Valid 911 or E911 addresses that are indicated as not being up-to-date may be replaced, by the system, with up-to-date 911 or E911 addresses in the one or more appropriate databases, the up-to-date 911 or E911 addresses being provided by the requesting party. In some examples, the system may utilize the emergency test call handler 225 to communicate (using simulated calls) with the emergency service provider system 165 to update the 911 or E911 addresses within the emergency service provider database(s) 170. For unknown 911 or E911 addresses, a similar process may be initiated, by the system, to request that accurate and up-to-date 911 or E911 addresses are provided by the requesting party, and once verified are added to the one or more appropriate databases, in a similar manner as above with respect to updating or replacing 911 or E911 addresses in the one or more appropriate databases.

FIGS. 3A and 3B (collectively, “FIG. 3”) depict various example sequence flows 300A and 300B for implementing emergency call record and address validation functionalities, in accordance with various embodiments. In some embodiments, requesting application(s) 205, emergency test call handler 225, emergency service provider system 165, response analysis system 230, requesting devices 210a-210w, validation requests 305 and 305a′-305w′, test calls 310 and 310′, call responses 315 and 315′, and results 320 and 320a′-320w′ of FIG. 3 may be similar, if not identical, to the requesting applications 205a-205w, the emergency test call handler 225, the emergency service provider system 165, the response analysis system 230, the requesting devices 210a-210w, validation requests 235a-235w and/or 240a-240w, test calls 250a-250v, call responses 255a-255v, and results 265a-265w, respectively, of sequence flow 200 of FIG. 2, and the description of these components of sequence flow 200 of FIG. 2 are similarly applicable to the corresponding components of FIG. 3.

With reference to the non-limiting example 300A of FIG. 3A, requesting application(s) 205 may send validation request 305 to emergency test call handler 225, which in turn may send test call 310 to emergency service provider system 165, e.g., as described above with respect to FIG. 2. Emergency service provider system 165 may send call response 315 to response analysis 230, which may in turn send result 320 to requesting device 210a and/or the requesting application(s) 205, e.g., as also described above with respect to FIG. 2. In examples, validation request 305 may request to validate a 911 or E911 address associated with a first telephone number, and may include the first telephone number in a payload portion of the request 305. In some instances, test call 310 may simulate emergency services validation call, and may include the first telephone number in a payload portion of the test call 310. In some cases, call response 315 may return a validation result for the 911 or E911 address associated with the first telephone number, the validation result indicating whether the 911 or E911 address is accurate or not accurate. In some examples, result 320 may be either a positive result 320a or a negative result 320b. In examples, a positive result 320a may include a message such as “Your Subscriber Identifier is <Include telephone number dialed>, and your location is known <Include 911 or E911 address>. Your call will go to PSAP <Include PSAP ID>.” Herein, the italicized text between “<” and “>” indicates what additional information (e.g., telephone number dialed, 911 or E911 address, PSAP ID, etc.) is included in the message. In some examples, a negative result 320b may include a message such as “Your Subscriber Identifier is <Include telephone number dialed>, and your location is unknown. Your call will go to a call center.” In some cases, the call center includes an emergency call response center or the like.

Referring to the non-limiting example 300B of FIG. 3B, at least one requesting application 205 may send two or more validation requests 305a′-305w′ (collectively, “requests 305′”) to emergency test call handler 225, which in turn may send test call 310′ to emergency service provider system 165, e.g., as described above with respect to FIG. 2. Emergency service provider system 165 may send call response 315′ to response analysis 230, which may in turn send two or more results 320a′-320w′ to corresponding two or more requesting devices 210a-210w and/or the at least one requesting application 205, e.g., as also described above with respect to FIG. 2. In examples, each validation request 305′ may request to validate a 911 or E911 address associated with a corresponding telephone number, and may include said corresponding telephone number in a payload portion of the request 305′. For example, a first validation request 305a′ may request to validate a first 911 or E911 address associated with a first telephone number, and may include the first telephone number in a payload portion of the first request 305a′. In some instances, test call 310′ may simultaneously simulate two or more emergency services validation calls, and may include a list of corresponding two or more telephone numbers in a payload portion of the test call 310′. In some cases, call response 315′ may return validation results for the 911 or E911 addresses associated with the two or more telephone numbers, the validation results indicating whether each 911 or E911 address is accurate or not accurate (e.g., the first telephone number being current, up-to-date, or accurate, the second telephone number not being current, up-to-date, or accurate, etc.). In some examples, each of results 320a′-320w′ may be either a positive result (e.g., result(s) 320a′) or a negative result (e.g., result(s) 320b′). In examples, a positive result 320a′ may include a message such as “Your Subscriber Identifier is <Include first telephone number>, and your location is known <Include 911 or E911 address>. Your call will go to PSAP <Include PSAP ID>.” In some examples, a negative result 320b′ may include a message such as “Your Subscriber Identifier is <Include second telephone number>, and your location is unknown. Your call will go to a call center.”

FIGS. 4A and 4B (collectively, “FIG. 4”) depict flow diagrams illustrating various example methods 400A and 400B for implementing emergency call record and address validation, in accordance with various embodiments.

While the techniques and procedures are depicted and/or described in a certain order for purposes of illustration, it should be appreciated that certain procedures may be reordered and/or omitted within the scope of various embodiments. Moreover, while the example methods 400A and 400B illustrated by FIGS. 4A and 4B can be implemented by or with (and, in some cases, are described below with respect to) the systems, examples, or embodiments 100, 200, 300A, and 300B of FIGS. 1, 2, 3A, and 3B, respectively (or components thereof), such methods may also be implemented using any suitable hardware (or software) implementation. Similarly, while each of the systems, examples, or embodiments 100, 200, 300A, and 300B of FIGS. 1, 2, 3A, and 3B, respectively (or components thereof), can operate according to the example methods 400A and 400B illustrated by FIGS. 4A and 4B (e.g., by executing instructions embodied on a computer readable medium), the systems, examples, or embodiments 100, 200, 300A, and 300B of FIGS. 1, 2, 3A, and 3B can each also operate according to other modes of operation and/or perform other suitable procedures.

In the non-limiting embodiment of FIG. 4A, method 400A, at operation 405, may include receiving, by a computing system and from at least one requesting application, two or more validation requests corresponding to the two or more test calls. Each validation request is set to request to validate a 911 or E911 address associated with a corresponding telephone number among the plurality of telephone numbers associated with the corresponding plurality of users. Method 400A further includes, at operation 410, routing, by the computing system, the two or more validation requests to a messaging bus that prioritizes a call queue for simultaneously initiating the two or more test calls to an emergency service provider system. In some embodiments, the computing system includes at least one of an emergency call record and address validation system, an emergency test call handler, a 911 or E911 address validation system, a 911 or E911 address change server, a NOC, a cloud computing system, or a distributed computing system, and/or the like.

At operation 415, method 400A may include simultaneously initiating, by the computing system, two or more test calls among a plurality of test calls to the emergency service provider system. Each test call may simulate an emergency services validation call initiated from a telephone number among a plurality of telephone numbers associated with a corresponding plurality of users to request a determination as to whether a 911 or E911 address associated with the telephone number is an accurate 911 or E911 address and to request sending of a call response back to the computing system. The method 400A may further include receiving a corresponding plurality of call responses from the emergency service provider system (at operation 420); analyzing, by the computing system, each call response to determine a result of each corresponding simulated emergency services validation call (at operation 425); and sending, by the computing system, each determined result to a corresponding requesting party (at operation 430).

In some instances, each of the two or more validation requests is sent from the at least one requesting application in response to one of: a manual request from a requesting party; or an automated request by the at least one requesting application on behalf of the user associated with the telephone number corresponding to one of the two or more validation requests. In some instances, the requesting party is one of a user associated with a telephone number corresponding to one of the two or more validation requests or a service representative of a service provider providing a voice service associated with the telephone number. In some cases, the automated request is initiated as one of a periodic automated request, a scheduled automated request, or a triggered automated request, and/or the like. In some examples, the triggered automated request is initiated in response to a trigger including one of a request for a new voice service subscription, a request for a change in voice service subscription, a request for a new telephone number, a request for a change of users to whom the voice service is assigned, a request for a change of users to whom a telephone number is assigned, a request for updating a user's address, or an on-demand request to validate a 911 or E911 address by a user, and/or the like.

In some cases, at least one of the two or more validation requests and at least one of the two or more test calls among the plurality of test calls each includes the corresponding telephone number and the corresponding 911 or E911 address associated with said telephone number. In some instances, determining whether the corresponding 911 or E911 address associated with said telephone number is an accurate 911 or E911 address includes determining whether the corresponding 911 or E911 address associated with said telephone number matches a corresponding 911 or E911 address that is stored in a database containing 911 or E911 addresses that have previously been validated. In examples, each 911 or E911 address for the corresponding telephone number associated with a corresponding one of the two or more test calls is stored in 911 or E911 address data. For each of the two or more test calls, determining whether a 911 or E911 address associated with a corresponding telephone number is an accurate 911 or E911 address includes comparing each 911 or E911 address for the corresponding telephone number associated with a corresponding one of the two or more test calls with a corresponding address contained in a government postal address database.

In some cases, analyzing each call response includes analyzing, by the computing system, each call response using at least one of voice recognition technology, call detail record analysis, log data analysis, or analysis of unique tones generated by the emergency service provider system, and/or the like, to determine the result of each corresponding simulated emergency services validation call. In some instances, sending each determined result to a corresponding requesting party includes sending each determined result to a corresponding requesting party via at least one of a service order user interface (“UI”), an email message, a test message, a telephone or voice call to a corresponding telephone number associated with a corresponding user among the plurality of users, or a telephone or voice call to an administrator telephone number associated with one or more of the corresponding telephone number or the corresponding user, and/or the like.

In some embodiments, sending each determined result includes, based on a determination that a determined result among the determined results associated with two or more test calls is positive, sending the determined result to the corresponding requesting party, the determined result including the corresponding telephone number, the corresponding 911 or E911 address, and information regarding a corresponding PSAP among a plurality of PSAPs to which emergency calls from the corresponding telephone number are directed. Alternatively or additionally, sending each determined result includes, based on a determination that a determined result among the determined results associated with two or more test calls is negative, sending the determined result to the corresponding requesting party, the determined result including the corresponding telephone number and a message indicating that the corresponding 911 or E911 address is unknown and indicating that the corresponding test call will be routed to a call center for updating the corresponding 911 or E911 address.

Referring to the non-limiting example of FIG. 4B, method 400B, at operation 435, may include receiving, by a computing system and from a requesting application, a first validation request to validate a first 911 or E911 address associated with a first telephone number among a plurality of telephone numbers associated with a corresponding plurality of users. Method 400B may further include, at operation 440, routing, by the computing system, the first validation request to a messaging bus that prioritizes a call queue for simultaneously initiating a plurality of test calls to an emergency service provider system. The plurality of test calls may simulate emergency services validation calls initiated from a corresponding plurality of telephone numbers associated with a corresponding plurality of users.

At operation 445, method 400B may include initiating, by the computing system, a first test call among the plurality of test calls to the emergency service provider system. The first test call may simulate an emergency services validation call initiated from a first telephone number associated with a first user to request a determination as to whether a 911 or E911 address associated with the first telephone number is an accurate 911 or E911 address and to request sending of a call response back to the computing system. Method 400B may further include receiving, by the computing system, the call response from the emergency service provider system (at operation 450); analyzing, by the computing system, the call response to determine a result of the simulated emergency services validation call (at operation 455); and sending, by the computing system, the determined result to a requesting party (at operation 460). In some cases, the requesting party includes the first user, an agent of the first user, or a service representative of a service provider providing a voice service associated with the first telephone number, and/or the like.

In some instances, the first validation request is sent from the requesting application in response to one of: a manual request from the requesting party; or an automated request by the requesting application on behalf of the requesting party, and/or the like. In some cases, the automated request is initiated as one of a periodic automated request, a scheduled automated request, or a triggered automated request, and/or the like. In some examples, the triggered automated request is initiated in response to a trigger including one of a request for a new voice service subscription, a request for a change in voice service subscription, a request for a new telephone number, a request for a change of users to whom the voice service is assigned, a request for a change of users to whom a telephone number is assigned, a request for updating a user's address, or an on-demand request to validate a 911 or E911 address by a user, and/or the like.

According to some embodiments, the first validation request and a first test call among the plurality of test calls each includes the first telephone number and the first 911 or E911 address associated with the telephone number. In some instances, determining whether the 911 or E911 address associated with the telephone number is an accurate 911 or E911 address includes determining whether the first 911 or E911 address associated with the first telephone number matches a 911 or E911 address that is stored in a database containing 911 or E911 addresses that have previously been validated. In some cases, sending the determined result to the requesting party includes sending the determined result to the requesting party via at least one of a service order UI, an email message, a test message, a telephone or voice call to a corresponding telephone number associated with the first user, or a telephone or voice call to an administrator telephone number associated with one or more of the first telephone number or the first user, and/or the like.

In some embodiments, sending the determined result to the requesting party includes, based on a determination that the determined result associated with the first test call is positive, sending the determined result to the requesting party. The determined result includes the first telephone number, the 911 or E911 address associated with the first telephone number, and information regarding a corresponding PSAP among a plurality of PSAPs to which emergency calls from the first telephone number are directed. Alternatively or additionally, sending the determined result to the requesting party includes, based on a determination that the determined result associated with the first test call is negative, sending the determined result to the requesting party, the determined result including the first telephone number and a message indicating that the 911 or E911 address associated with the first telephone number is unknown and indicating that the first test call will be routed to a call center for updating said 911 or E911 address.

### Exemplary System and Hardware Implementation

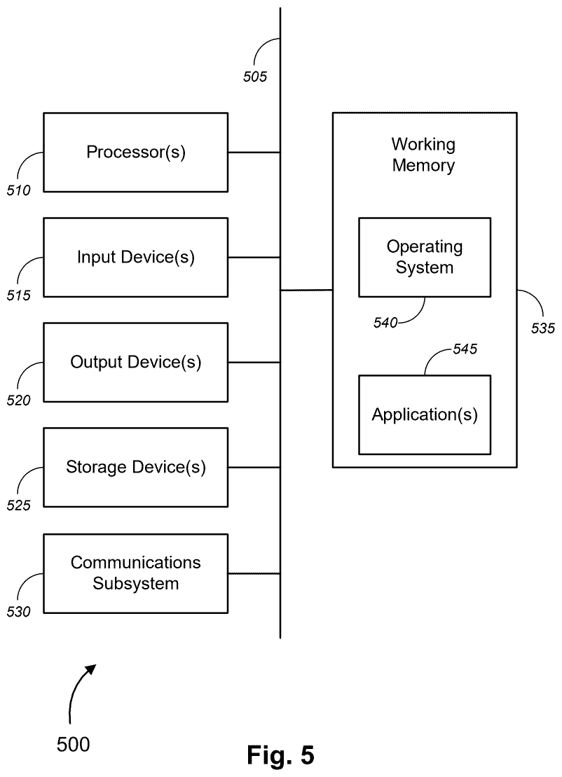

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., emergency call record and address validation system 105, user device(s) 130, call devices 135a-135y, gateway 145a, address validation engine 155, routers 160, emergency service provider servers or systems 165, PSAPs 175a-175z, geo-location system 185, requesting devices 210a-210w, 911 validation endpoint system(s) 215, messaging bus 220, emergency test call handler 225, and response analysis system 230, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., emergency call record and address validation system 105, user device(s) 130, call devices 135a-135y, gateway 145a, address validation engine 155, routers 160, emergency service provider servers or systems 165, PSAPs 175a-1752, geo-location system 185, requesting devices 210a-210w, 911 validation endpoint system(s) 215, messaging bus 220, emergency test call handler 225, and response analysis system 230, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
simultaneously initiating, by a computing system, two or more test calls among a plurality of test calls to an emergency service provider system, each test call simulating an emergency services validation call initiated from a telephone number among a plurality of telephone numbers associated with a corresponding plurality of users to request a determination as to whether a 911 or enhanced 911 (“E911”) address associated with the telephone number is an accurate 911 or E911 address and to request sending of a call response back to the computing system;
in response to receiving a corresponding plurality of call responses from the emergency service provider system, analyzing, by the computing system, each call response to determine a result of each corresponding simulated emergency services validation call; and
sending, by the computing system, each determined result to a corresponding requesting party.

2. The method of claim 1, wherein the computing system comprises at least one of an emergency call record and address validation system, an emergency test call handler, a 911 or E911 address validation system, a 911 or E911 address change server, a network operations center (“NOC”), a cloud computing system, or a distributed computing system.

3. The method of claim 1, further comprising:
receiving, by the computing system and from at least one requesting application, two or more validation requests corresponding to the two or more test calls, each validation request requesting to validate a 911 or E911 address associated with a corresponding telephone number among the plurality of telephone numbers associated with the corresponding plurality of users; and
routing, by the computing system, the two or more validation requests to a messaging bus that prioritizes a call queue for simultaneously initiating the two or more test calls to the emergency service provider system.

4. The method of claim 3, wherein each of the two or more validation requests is sent from the at least one requesting application in response to one of:
a manual request from a requesting party, wherein the requesting party is one of a user associated with a telephone number corresponding to one of the two or more validation requests or a service representative of a service provider providing a voice service associated with the telephone number; or
an automated request by the at least one requesting application on behalf of the user associated with the telephone number corresponding to one of the two or more validation requests, wherein the automated request is initiated as one of a periodic automated request, a scheduled automated request, or a triggered automated request.

5. The method of claim 4, wherein the triggered automated request is initiated in response to a trigger including one of a request for a new voice service subscription, a request for a change in voice service subscription, a request for a new telephone number, a request for a change of users to whom the voice service is assigned, a request for a change of users to whom a telephone number is assigned, a request for updating a user's address, or an on-demand request to validate a 911 or E911 address by a user.

6. The method of claim 3, wherein at least one of the two or more validation requests and at least one of the two or more test calls among the plurality of test calls each includes the corresponding telephone number and the corresponding 911 or E911 address associated with said telephone number, and wherein determining whether the corresponding 911 or E911 address associated with said telephone number is an accurate 911 or E911 address comprises determining whether the corresponding 911 or E911 address associated with said telephone number matches a corresponding 911 or E911 address that is stored in a database containing 911 or E911 addresses that have previously been validated.

7. The method of claim 1, wherein each 911 or E911 address for the corresponding telephone number associated with a corresponding one of the two or more test calls is stored in 911 or E911 address data, wherein, for each of the two or more test calls, determining whether a 911 or E911 address associated with a corresponding telephone number is an accurate 911 or E911 address comprises comparing each 911 or E911 address for the corresponding telephone number associated with a corresponding one of the two or more test calls with a corresponding address contained in a government postal address database.

8. The method of claim 1, wherein analyzing each call response comprises analyzing, by the computing system, each call response using at least one of voice recognition technology, call detail record analysis, log data analysis, or analysis of unique tones generated by the emergency service provider system to determine the result of each corresponding simulated emergency services validation call.

9. The method of claim 1, wherein sending each determined result to a corresponding requesting party comprises sending each determined result to a corresponding requesting party via at least one of a service order user interface (“UI”), an email message, a test message, a telephone or voice call to a corresponding telephone number associated with a corresponding user among the plurality of users, or a telephone or voice call to an administrator telephone number associated with one or more of the corresponding telephone number or the corresponding user.

10. The method of claim 1, wherein sending each determined result comprises at least one of:
based on a determination that a determined result among the determined results associated with two or more test calls is positive, sending the determined result to the corresponding requesting party, the determined result including the corresponding telephone number, the corresponding 911 or E911 address, and information regarding a corresponding public safety access point (“PSAP”) among a plurality of PSAPs to which emergency calls from the corresponding telephone number are directed; or
based on a determination that a determined result among the determined results associated with two or more test calls is negative, sending the determined result to the corresponding requesting party, the determined result including the corresponding telephone number and a message indicating that the corresponding 911 or E911 address is unknown and indicating that the corresponding test call will be routed to a call center for updating the corresponding 911 or E911 address.

11. A system, comprising:
a 911 validation endpoint system configured to receive validation requests from at least one requesting application to validate a first plurality of 911 or enhanced 911 (“E911”) addresses associated with a first plurality of telephone numbers that is associated with a corresponding first plurality of users;
a messaging bus configured to control and prioritize a call queue based on the requests received from the 911 validation endpoint system;
an emergency test call handler configured to simultaneously initiate two or more test calls among a plurality of test calls to an emergency service provider system and to receive a corresponding plurality of call responses from the emergency service provider system, each test call simulating an emergency services validation call initiated from a telephone number among the first plurality of telephone numbers; and
a response analysis system configured to, in response to receiving the corresponding plurality of call responses, analyze the plurality of call responses to determine results of each emergency services validation call simulated by the plurality of test calls and to send the determined results to each corresponding requesting party.

12. The system of claim 11, wherein the response analysis system is configured to analyze the plurality of call responses to determine results of each emergency services validation call by performing at least one of:
analyzing each call response using at least one of voice recognition technology, call detail record analysis, log data analysis, or analysis of unique tones generated by the emergency service provider system to determine the results of each corresponding simulated emergency services validation call;
determining whether the corresponding 911 or E911 address associated with the corresponding telephone number matches a 911 or E911 address that is stored in a database containing 911 or E911 addresses that have previously been validated; or
comparing each 911 or E911 address for the corresponding telephone number associated with a corresponding one of the two or more test calls with a corresponding address contained in a government postal address database.

13. A method, comprising:
initiating, by a computing system, a first test call to an emergency service provider system, the first test call simulating an emergency services validation call initiated from a first telephone number associated with a first user to request a determination as to whether a 911 or enhanced 911 (“E911”) address associated with the first telephone number is an accurate 911 or E911 address and to request sending of a call response back to the computing system;
in response to receiving the call response from the emergency service provider system, analyzing, by the computing system, the call response to determine a result of the simulated emergency services validation call; and
sending, by the computing system, the determined result to a requesting party, the requesting party comprising the first user, an agent of the first user, or a service representative of a service provider providing a voice service associated with the first telephone number.

14. The method of claim 13, wherein the computing system comprises at least one of an emergency call record and address validation system, an emergency test call handler, a 911 or E911 address validation system, a 911 or E911 address change server, a network operations center (“NOC”), a cloud computing system, or a distributed computing system.

15. The method of claim 13, further comprising:
receiving, by the computing system and from a requesting application, a first validation request to validate a first 911 or E911 address associated with the first telephone number among a plurality of telephone numbers associated with a corresponding plurality of users; and
routing, by the computing system, the first validation request to a messaging bus that prioritizes a call queue for simultaneously initiating a plurality of test calls to the emergency service provider system, the plurality of test calls simulating emergency services validation call initiated from a corresponding plurality of telephone numbers associated with a corresponding plurality of users.

16. The method of claim 15, wherein the first validation request is sent from the requesting application in response to one of:
a manual request from the requesting party; or
an automated request by the requesting application on behalf of the requesting party, wherein the automated request is initiated as one of a periodic automated request, a scheduled automated request, or a triggered automated request.

17. The method of claim 16, wherein the triggered automated request is initiated in response to a trigger including one of a request for a new voice service subscription, a request for a change in voice service subscription, a request for a new telephone number, a request for a change of users to whom the voice service is assigned, a request for a change of users to whom a telephone number is assigned, a request for updating a user's address, or an on-demand request to validate a 911 or E911 address by a user.

18. The method of claim 15, wherein the first validation request and a first test call among the plurality of test calls each includes the first telephone number and the first 911 or E911 address associated with the telephone number, and wherein determining whether the 911 or E911 address associated with the telephone number is an accurate 911 or E911 address comprises determining whether the first 911 or E911 address associated with the first telephone number matches a 911 or E911 address that is stored in a database containing 911 or E911 addresses that have previously been validated.

19. The method of claim 13, wherein sending the determined result to the requesting party comprises sending the determined result to the requesting party via at least one of a service order user interface (“UI”), an email message, a test message, a telephone or voice call to a corresponding telephone number associated with the first user, or a telephone or voice call to an administrator telephone number associated with one or more of the first telephone number or the first user.

20. The method of claim 13, wherein sending the determined result to the requesting party comprises at least one:
based on a determination that the determined result associated with the first test call is positive, sending the determined result to the requesting party, the determined result including the first telephone number, the 911 or E911 address associated with the first telephone number, and information regarding a corresponding public safety access point (“PSAP”) among a plurality of PSAPs to which emergency calls from the first telephone number are directed; or
based on a determination that the determined result associated with the first test call is negative, sending the determined result to the requesting party, the determined result including the first telephone number and a message indicating that the 911 or E911 address associated with the first telephone number is unknown and indicating that the first test call will be routed to a call center for updating said 911 or E911 address.
